(19) United States
(12) Patent Application Publication
(10) Pub. No.: US 2024/0020761 A1
(43) Pub. Date: Jan. 18, 2024

(54) SYSTEM, METHOD, AND COMPUTER PROGRAM FOR A MULTI-DIMENSIONAL CREDIT WORTHINESS EVALUATION

(71) Applicant: Yodlee, Inc., San Mateo, CA (US)

(72) Inventors: Ambar Bandyopadhyay, Kolkata (IN); Deepak Patil, Bangalore (IN); Om D. Deshmukh, Bangalore (IN); Pramod Singh, Apex, NC (US); Priyanka Sawant, Indore (IN); Sudarshan Pulapadi, Bangalore (IN); Vinay Manjunath, Bangalore (IN)

(21) Appl. No.: 17/866,290

(22) Filed: Jul. 15, 2022

(51) Int. Cl. G06Q 40/02; G06Q 20/40; G06N 20/00; G06Q 20/38

(52) U.S. Cl. CPC G06Q 40/025; G06Q 20/4016; G06N 20/00; G06Q 20/389

(57) ABSTRACT

As described herein, a system, method, and computer program are provided for a multi-dimensional credit worthiness evaluation. Financial transaction data is accessed for an individual. A plurality of dimensions of credit worthiness is computed for the individual, using the financial transaction data. At least one machine learning model is trained, using the financial transaction data and the plurality of dimensions of credit worthiness as training data, to make at least one financial-related prediction for additional individuals. The at least one machine learning model is output for use in making the at least one financial-related prediction for the one or more of the additional individuals.

### FIELD OF THE INVENTION

The present invention relates to processing financial transactions to determine credit worthiness of financial institution customers.

### BACKGROUND

Credit worthiness of an individual is typically estimated by one of the credit reporting companies based on how the individual has managed their credit account in terms of the duration of the relation, regularity of usage and completeness of repayment of each of their accounts. However, there are some shortcomings in the current techniques used to evaluate credit worthiness. Some of these shortcomings are: (a) Users who have little to no credit history find it difficult to either get access to any form of credit or the access is not at the terms and conditions that reflect their financial status; and (b) There is a significant lag between the actual change in a user's life-style, financial status and/or credit riskiness and when it reflects in the scores reported by the credit reporting companies (the lag is typically of 6 months, but is often even more), i.e. a user may exhibit credit-risky behavior like over-spending and/or loss-of-employment and it can take 6 months or more for that behavior to reflect in the user's credit score.

There is thus a need for addressing these and/or other issues associated with the prior art.

### SUMMARY

As described herein, a system, method, and computer program are provided for a multi-dimensional credit worthiness evaluation. Financial transaction data is accessed for an individual. A plurality of dimensions of credit worthiness is computed for the individual, using the financial transaction data. At least one machine learning model is trained, using the financial transaction data and the plurality of dimensions of credit worthiness as training data, to make at least one financial-related prediction for additional individuals. The at least one machine learning model is output for use in making the at least one financial-related prediction for the one or more of the additional individuals.

### BRIEF DESCRIPTION OF THE DRAWINGS

FIG. 1 illustrates a method for using a multi-dimensional credit worthiness evaluation for generating a machine learning model, in accordance with one embodiment.

FIG. 2 illustrates a method for computing a multi-dimensional credit worthiness evaluation for an individual, in accordance with one embodiment.

FIG. 3 illustrates a method for training at least one machine learning model to make financial-related predictions, in accordance with one embodiment.

FIG. 4 illustrates a network architecture, in accordance with one possible embodiment.

FIG. 5 illustrates an exemplary system, in accordance with one embodiment.

### DETAILED DESCRIPTION

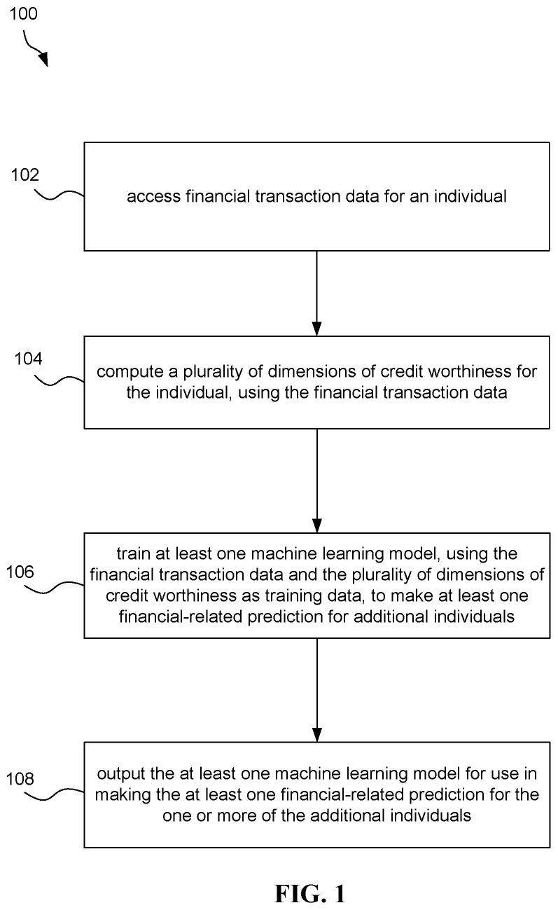

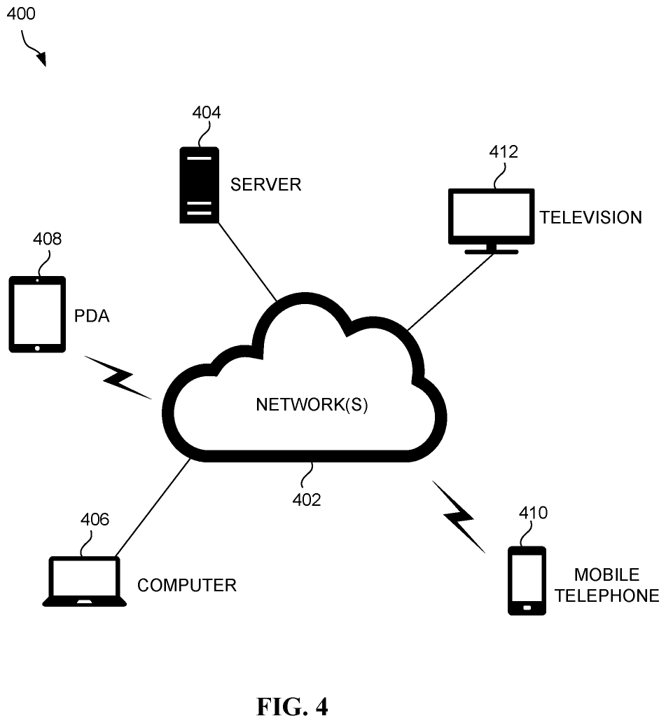

FIG. 1 illustrates a method 100 for using a multi-dimensional credit worthiness evaluation for generating a machine learning model, in accordance with one embodiment. The method 100 may be performed by any computer system, such as those described below with respect to FIGS. 4 and/or 5. For example, in one embodiment, the method 100 may be performed by a computer system interfacing a system of one or more financial institutions that generate financial transaction data based on the financial transactions of its customers (e.g. users, business entities, etc.), among other data systems. The computer system performing the method 100 may be a sub-system of one of the financial institutions, in another embodiment.

The method 100 is performed to generate one or more machine learning models capable of making financial-related predictions, which may in turn be used for financial account management. In the context of the present description, a “financial institution” refers to any entity that facilitates financial transactions for its customers, such as a banking entity. A financial transaction may be a monetary deposit, monetary withdrawal, monetary transfers, or any other transaction involving money.

In operation 102, financial transaction data is accessed for an individual. The individual is any person or entity (e.g. business entity) for which financial transactions have been performed by one or more financial institutions. Accordingly, the individual may be a customer of one or more financial institutions (e.g. may have an account with the financial institution(s)).

With respect to the present description, the financial transaction data is data associated with (e.g. recording, defining, etc.) prior financial transactions of the individual. In particular, the financial transaction data may include historical transactions performed using at least one account of the individual with at least one financial institution. The financial transaction data may be accessed from the financial institution(s).

In operation 104, a plurality of dimensions of credit worthiness is computed for the individual, using the financial transaction data. Each of the dimensions of credit worthiness may be computed (e.g. evaluated) using a corresponding predefined algorithm (e.g. equation, function, etc.). Each predefined algorithm may be applied to certain aspects of the financial transaction data.

In one embodiment, the plurality of dimensions of credit worthiness may include at least one lifestyle score. Each lifestyle score of the at least one lifestyle score may be a quantification of a spending pattern of the individual. In another embodiment, the plurality of dimensions of credit worthiness may include at least one income score. Each income score of the at least one income score may be a quantification of an income of the individual.

In yet another embodiment, the plurality of dimensions of credit worthiness may include at least one financial behavior score. For example, the at least one financial behavior score may include at least one priority expense score, where each priority expense score of the at least one priority expense score may be a quantification of a priority expense of the individual. As another example, the at least one financial behavior score may include at least one current credit-exclusivity score, where each current credit-exclusivity score of the at least one current credit-exclusivity score may be a quantification of a positive credit performance of the individual. As still yet another example, the at least one financial behavior score may include at least one financial discipline score, where each financial discipline score of the at least one financial discipline score may be a quantification of a financial discipline of the individual. In a further example, the at least one financial behavior score may include at least one red-flag event score, where each red-flag event score of the at least one red-flag event score may be a quantification of poor financial planning by the individual.

In operation 106, at least one machine learning model is trained, using the financial transaction data and the plurality of dimensions of credit worthiness as training data, to make at least one financial-related prediction for additional individuals. The additional individuals refer to other persons or entities that use one or more of the financial institutions for completing financial transactions (e.g. that are customers of the financial institution(s)).

It should be noted that the training data may include certain aspects of the financial transaction data, as well as certain dimensions from the computed dimensions of credit worthiness. Further, the training data may be different for each machine learning model, per the type of training data required to train a corresponding machine learning model to make a desired type of prediction.

In one embodiment, the at least one financial-related prediction may include a prediction of risk in financial behavior of the additional individuals, when an amount of available financial transactions data for the additional individuals is below a threshold. In another embodiment, the at least one financial-related prediction may include a prediction of imminent financial trouble for the additional individuals. In yet another embodiment, the at least one financial-related prediction may include a prediction of fraud by the additional individuals. In a further embodiment, the at least one financial-related prediction may include a prediction of a need for a credit upgrade by the additional individuals.

In operation 108, the at least one machine learning model is output for use in making the at least one financial-related prediction for the one or more of the additional individuals. In one embodiment, the machine learning model(s) may be output to the financial institution(s) for use in making the at least one financial-related prediction for the one or more of the additional individuals. In this way, the financial institution(s) may use those predictions when managing (e.g. taking action in association with) the financial accounts of those additional individuals.

In one embodiment, the method 100 may also include using the at least one machine learning model to make the at least one financial-related prediction for the one or more of the additional individuals. In another embodiment, the method 100 may also include outputting one or more dimensions of credit worthiness of the plurality of dimensions of credit worthiness to a financial institution. For example, select dimension(s) of credit worthiness computed for the individual may be output for use by the financial institution as a basis for performing one or more financial-related activities for the individual.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

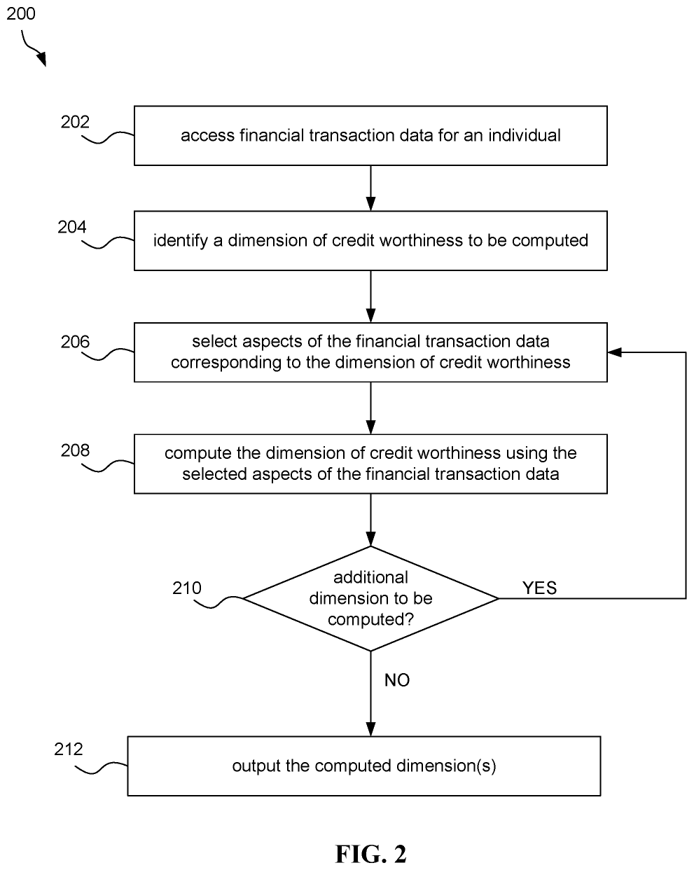

FIG. 2 illustrates a method 200 for computing a multi-dimensional credit worthiness evaluation for an individual, in accordance with one embodiment. As an option, the method 200 may be carried out in the context of the details of the previous figure and/or any subsequent figure(s). Of course, however, the method 200 may be carried out in the context of any desired environment. Further, the aforementioned definitions may equally apply to the description below.

In operation 202, financial transaction data for an individual is accessed. In one embodiment, the financial transaction data may be a list of financial transactions of the individual over a period of 3 or more months. Note that the longer the duration of transactions, the more comprehensive the multi-dimensional credit worthiness evaluation will be. In another embodiment, the raw financial transactions may be processed through a transaction enrichment system which extracts certain details from the transaction, such as the merchant where the transaction occurred, the category of the transaction (e.g. credit, debit, etc.), and/or the geo-location of the transaction (e.g., specified city, online, etc.). Thus, a known set of enriched parameters may be generated for the financial transaction data.

In operation 204, a dimension of credit worthiness to be computed is identified. In operation 206, aspects of the (e.g. enriched) financial transaction data, which correspond to the dimension of credit worthiness, are selected. In operation 208, the dimension of credit worthiness is computed using the selected aspects of the financial transaction data.

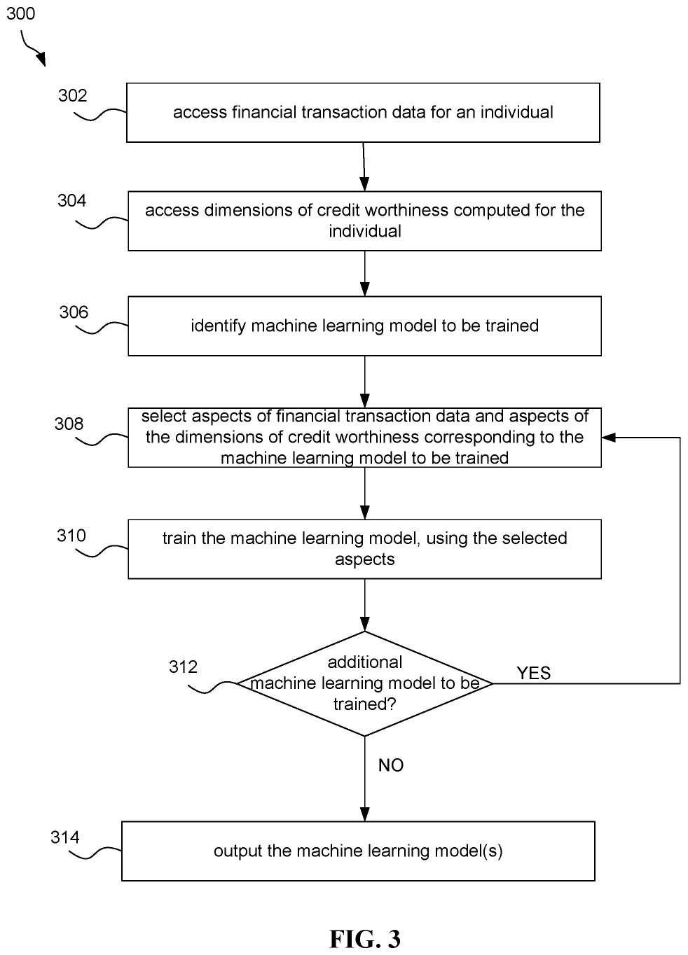

In decision 210, it is determined whether an additional dimension of credit worthiness is to be computed. When it is determined that an additional dimension of credit worthiness is to be computed, the method 200 repeats operations 204-208 for the additional dimension of credit worthiness. In this way, a multi-dimensional credit worthiness evaluation may be performed. In operation 212, the computed dimension(s) are output. For example, the computed dimension(s) may be output to a financial institution used by the individual. As another example, the computed dimension(s) may be output for use in the method 300 of FIG. 3 described below.

The following description provides embodiments of the various dimensions of credit worthiness that may be computed for the individual (also referred to as a user).

Lifestyle score: This dimension captures the individual's spending patterns. Each spending category is bucketed as either discretionary or essential. Essential categories include utilities, transportation, general merchandise, groceries-or-restaurants, rent-or-mortgage, insurance. Some categories are conditionally-essential. For example, if the individual shows minimum expenses on groceries, then restaurants becomes as essential category. The ‘minimum expenses on groceries’ mentioned above is computed as follows: for all the users in our training data, we quantize the groceries expenses in 5 quantiles. The median value in the lowest quantile is the ‘minimum expenses on groceries’. The minimum expenses for other categories of interest are computed similarly. The expenses in each of the essential and discretionary categories are normalized in two ways: (a) the type-A normalization is relative to the expenditure in the particular category across all the users. Specifically, catgₙ₁=2*(sigmoid(ω*Cᵢ)−0.5); and (b) the type-B normalization is relative to the overall expenditure of that user. Specifically, catgₙ₂=Cᵢ/sum(Cⱼ), where Ci is the dollar amount spent on category-i, the sum( ) is the sum of the dollar amount spent on all the categories and w is a weight factor set experimentally to allow for a good spread in the distribution. The normalized values in the essential categories are averaged to compute the essential lifestyle score (E). Likewise, we have the discretionary lifestyle score (D) and the overall lifestyle score (O). In addition to these three lifestyle scores, a vector (L) of each of the individual normalized categories is also maintained. One way in which this dimension is used to find users with high credit-risk are users with a high D value but a low E value.

Income score: This dimension computes the individual's income score. The income source of the individual is bucketed into multiple sub-dimensions: (a) regular versus irregular: Income from Salary category is right away bucketed as ‘regular’ whereas income from Deposits category is right away bucketed as ‘irregular’. For all the other categories of income (e.g. retirement earnings, securities earnings) a data-driven periodicity detection model is used to decide if the income is regular or irregular; and (b) active versus passive: Income from Government Grants (like Child Support), Retirement Earnings, Interest Income are bucketed as passive, whereas income from Salary, gig-initiatives like a weekend Uber driving stint are bucketed as active; and (c) Sudden versus predictable: Any income transaction whose dollar amount is more than 3 times the median dollar amount of all income transactions is bucketed as sudden-income. Each of these sub-dimensions is normalized using the type-B normalization mentioned above. The normalized total income is called the overall income score (S). The proportion of total income that is regular and active and predictable is termed as the reliable income score (R). Users with a high proportion of sudden income will need special treatment for that point-in-time. For example, one such user may decide to utilize the sudden income to reduce his/her outstanding debt while another user may decide to use this sudden income to spend on a one-off expense like an international vacation or a home renovation. We have another binary score, called sudden-income-score to capture the user's behavior in response to sudden incomes. The sudden income score can take a value of either ‘debt-free’ or ‘lifestyle’. In addition to these specific income related scores, a vector (I) of each of the individual normalized income categories is also maintained.

Financial behavior score: This dimension captures two specific aspects:

1. Priority expenses: Priority expenses are the expenses that regularly occur soon after a monetary inflow occurs in the account. For example, for a given user, if a credit-card payment outflow happened within a week of salary hitting the account in 9 out of the last 12 months, then credit-card-payment is labeled as a priority expense. Each of the priority expenses is quantified as the proportion of the particular income that went into the specific expense. Another binary score, called priority-expense-score is computed to capture the user's behavior. The priority-expense-score can take a value of either ‘debt-free’ or ‘lifestyle’ depending on whether majority of the expense is towards discretionary spends or towards essential spends. For this computation, the following additional categories are also considered as essential, along with the ones mentioned above: (a) credit card payment, (b) savings, (c) investment and (d) transfers.

2. Current Credit-exclusivity score: This score captures factors which are indicative of positive credit performance. The factors we consider for this are: (a) the type of credit card: we have categorized ˜5K different types of credit cards into “mainstream”, “exclusive”, “platinum”. Mainstream gets a score of 1, exclusive a score of 2 and platinum a score of 3. (b) Similarly, we assign a score of 1, 2 or 3 if the annual percentage rate (APR) on the existing credit card is in the top one-third, or mid-one-third or the lowest one-third. (c) The existing loans that the user has are also assigned a score of 1, 2, or 3 based on whether the loan provider is top of the line, mainstream or subprime. The labeling of the loan providers into these buckets is done by subject matter experts and can be updated systematically. The final credit-exclusivity score is an average of the above three factors.

3. Financial discipline score: This score captures the financial discipline the user has. The factors we consider here are: (a) the proportion of the credit card outstanding that is paid regularly. The score is 1, 2, or 3 based on whether the proportion paid is up to one-third or between one-third to two-third or beyond two-third of the outstanding amount. (b) if the user has set up auto-payments and the auto-payments are honored for credit card payment, utilities payment, subscriptions payment, the score is 1, else it is 0. (c) If the user has closed any of the outstanding loans in the past 24 months, then a score of 1 is assigned, else it is 0. The final financial-discipline score is an average of the above three factors.

4. Red-flag events: Red flag events are indicative of less financial planning on the user's part. Some of the red flag events we consider are: (a) payment to a collection agency, (b) salary advance loans or similar loans which are seen as subprime, (c) loans from known subprime lenders, (d) high amount of credit card roll over balance in combination with a high amount of net new discretionary spends (e.g., an international travel), (e) cash advances from a credit card. Each of the red flag event is quantified using the type-B normalization mentioned above and the sum of all of them is also quantified using the type-B normalization.

FIG. 3 illustrates a method 300 for training at least one machine learning model to make financial-related predictions, in accordance with one embodiment. As an option, the method 200 may be carried out in the context of the details of the previous figure and/or any subsequent figure(s). Of course, however, the method 200 may be carried out in the context of any desired environment. Further, the aforementioned definitions may equally apply to the description below.

In operation 302, financial transaction data for an individual is accessed. The financial transaction data may be the enriched data from operation 202 of FIG. 2, as an option. In operation 304, dimensions of credit worthiness computed for the individual are accessed. These dimensions of credit worthiness may be those output in FIG. 2. Similarly, operations 302-304 may be repeated or additional individuals.

In operation 306, a machine learning model to be trained is identified. In operation 308, aspects of the financial transaction data and aspects of the dimensions of credit worthiness corresponding to the machine learning model are selected. The aspects may be those required to train the machine learning model to make a certain prediction.

In operation 310, the machine learning model is trained using the selected aspects of the financial transaction data and the selected aspects of the dimensions of credit worthiness. In decision 312, it is determined whether an additional machine learning model is to be trained. When it is determined that an additional machine learning model is to be trained, the method 300 repeats operations 308-310 for the additional machine learning model.

In operation 314, the machine learning model(s) are output. For example, the machine learning model(s) may be output to a financial institution for use in making financial-related predictions for one or more of the additional individuals.

The following description provides embodiments of the various predictions that may be made using the machine learning model(s) described above.

Risky financial behavior of thin-file users: Thin-file users, by definition, have limited (e.g. about 3-4 months) of digital financial transactions data. Predicting their financial behavior based just on this tiny sliver of information is a tough job. Our proposed machine learning model works in the following way: From all the users for whom we have financial transaction data, we select users, called class-A users, who have shown significantly bad financial behavior (specifically, had collection agency related expenses, and/or had high amounts of credit card balance carried forward and/or had high banking fees) and separately select users, called class-B users, who have shown significantly good financial behavior (specifically, have regular near-complete credit card balance paid, and/or have the most exclusive credit cards, and/or have multiple loans from the best loan providers). For each of these users we go back in history until we find 4 consecutive months of transaction data where no loans were available, no standard credit card payments were available [If this condition is not met, that user is simply dropped from any further consideration]. This 4-month data can now be considered as proxy thin-file data for each of the users. We then compute a list of features based on the spending patterns across merchants and categories and earning patterns across categories for each of these users. These features are normalized using both type-A and type-B normalization mentioned above. A feed forward neural network classifier is then trained to classify a given user into either class-A or class-B. The probability of predicting class-A label for a given user is the risky-financial-behavior score.

Imminent financial trouble: The credit score as reported by various credit reporting companies lags the actual financial behavior by, at least, a good 6 months. We use the granularity of financial transaction data along with the various scores computed above to predict the probability of imminent financial trouble for every user on a monthly basis. This probability is computed in the following way: From all our users, we first identified a set of users who had financial trouble like a collection agency fees, high credit card balance carry forward. We also identified the specific month when the particular financial trouble happened first. We then compute the above-mentioned financial scores along with the detailed financial transaction enrichment based features for each of the 12 months preceding the troubled month. These scores form a long numeric vector. We then find users, from the above list, for whom the cosine similarity between the consecutive month-on-month features did not vary beyond an acceptable threshold. Such users are ignored from the rest of the analysis under the assumption that they were always in financial trouble. For the rest of the users, we create a centroid (c) of their feature set for using the data from the three months preceding the troubled month. Now, for any new user whose financial-trouble-probability is to be predicted, we compute the last three months feature set as described above. The cosine similarity of this feature set and the centroid (c) is computed. This cosine similarity is the probability of imminent financial trouble for that user.

Bust-out fraud: Bust out fraud is when a user keeps building good financial behavior to get credit cards with higher credit limits and then quickly maxes out on these credit cards with no intention of repaying. Given the lag in predicting financial trouble by the credit reporting companies and the actual signs of financial trouble, detecting such frauds is a tough task. The financial scores mentioned above can be used for early detection of such frauds. If the ratio of the discretionary lifestyle score (D) and the reliable income score (R) goes up abruptly while the ratio of the essential lifestyle score (E) and the reliable income score (R) does not, along with no significant increase in the overall income score (S), then it is indicative of a likely bust-out fraud. In such cases, the bust-out fraud confidence is calculated as the difference of D₍ᵢ₊₁₎/E₍ᵢ₊₁₎ and Dᵢ/Eᵢ. The financial institution can decide the thresholds at which to set alerts for such likely bust-out frauds.

Credit upgrade: Certain life stage changes have a high chance of being followed by a noticeable credit upgrade. Some of these are: marriage, arrival of kids, a home purchase, change of employment, change of residence, purchase of a new vehicle. If a financial institution is able to predict these credit upgrade stages and proactively offer enhanced line of credit or more appropriate credit cards, then the user retention and user engagement will go up multifold. Basing these credit upgrade decisions on one of the individual life stage changes mentioned above is quite misleading. Instead, we have developed a holistic method which use the financial scores computed above along with other details from the financial transaction enrichments to predict users who will likely need a credit upgrade. The method works as follows: From all our users, we first identified a set of users who had a credit upgrade in recent past. A credit upgrade for this purpose is defined as instances where the credit card limit across all the cards for a given user went up by more than 50% with a less than 10% increase in total credit card balance carry forward. We also identified the specific month when the credit upgrade happened for each of the users. We then compute the above-mentioned financial scores along with the detailed financial transaction enrichment based features for six months preceding the credit upgrade month. These scores form a long numeric vector for each user. We then create a centroid (k) of this feature set across all the selected users. Now, for any new user whose credit-upgrade-probability is to be predicted, we compute the last six months' feature set as described above. The cosine similarity of this feature set and the centroid (k) is computed. This cosine similarity is the probability of credit upgrade for that user.

### SUMMARY

The embodiments described above provide a technique that analyses a user's financial transactions to quantify his/her financial behavior along multiple dimensions which reflect the overall credit worthiness of that user. Such a multi-dimensional alternate creditworthiness score has multiple applications: (a) it can help identify areas of improvements for every individual as part of financial counselling, (b) it gives greater control to the credit decisioning authority at a financial institution, (c) it helps alert relevant authorities about credit frauds that are likely to happen (in particular bust-out credit frauds), (d) it helps alert relevant authorities about sudden, positive or negative, changes in a user's lifestyle which have an impact on his/her credit-worthiness, (e) it helps make a more realistic evaluation of creditworthiness of a thin-file user, (f) it supports identification of cohort of users whose financial transaction patterns indicate positive credit behavior. For example, financial institutions can consider marketing tailored product offerings to increase their engagement.

FIG. 4 illustrates a network architecture 400, in accordance with one possible embodiment. As shown, at least one network 402 is provided. In the context of the present network architecture 400, the network 402 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 402 may be provided.

Coupled to the network 402 is a plurality of devices. For example, a server computer 404 and an end user computer 406 may be coupled to the network 402 for communication purposes. Such end user computer 406 may include a desktop computer, lap-top computer, and/or any other type of logic. Still yet, various other devices may be coupled to the network 402 including a personal digital assistant (PDA) device 408, a mobile phone device 410, a television 412, etc.

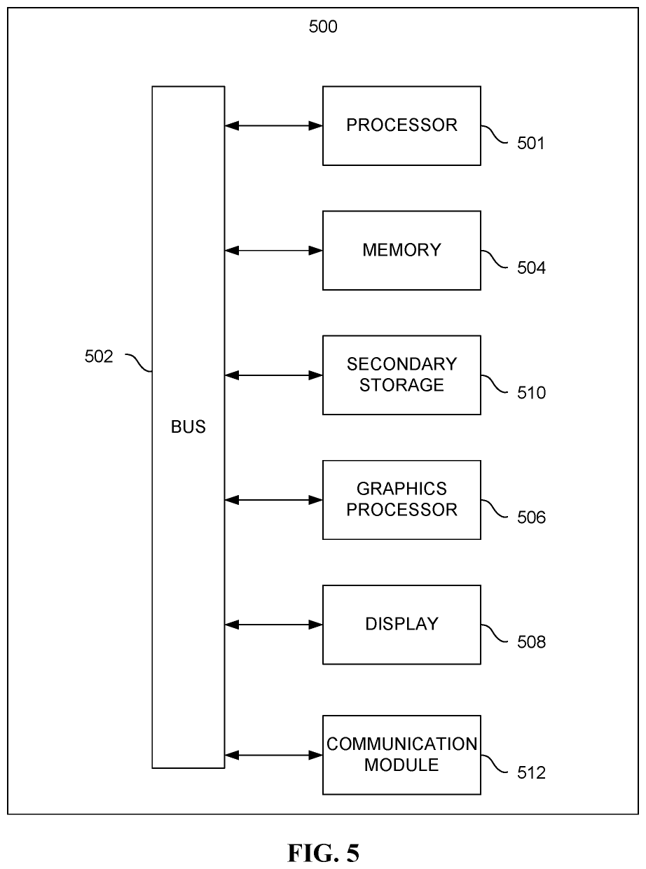

FIG. 5 illustrates an exemplary system 500, in accordance with one embodiment. As an option, the system 500 may be implemented in the context of any of the devices of the network architecture 500 of FIG. 5. Of course, the system 500 may be implemented in any desired environment.

As shown, a system 500 is provided including at least one central processor 501 which is connected to a communication bus 502. The system 500 also includes main memory 504 [e.g. random access memory (RAM), etc.]. The system 500 also includes a graphics processor 506 and a display 508.

The system 500 may also include a secondary storage 510. The secondary storage 510 includes, for example, solid state drive (SSD), flash memory, a removable storage drive, etc. The removable storage drive reads from and/or writes to a removable storage unit in a well-known manner.

Computer programs, or computer control logic algorithms, may be stored in the main memory 504, the secondary storage 510, and/or any other memory, for that matter. Such computer programs, when executed, enable the system 500 to perform various functions (as set forth above, for example). Memory 504, storage 510 and/or any other storage are possible examples of non-transitory computer-readable media.

The system 500 may also include one or more communication modules 512. The communication module 512 may be operable to facilitate communication between the system 500 and one or more networks, and/or with one or more devices through a variety of possible standard or proprietary communication protocols (e.g. via Bluetooth, Near Field Communication (NFC), Cellular communication, etc.).

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that several of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A non-transitory computer-readable media storing computer instructions which when executed by one or more processors of a device cause the device to:
access financial transaction data for an individual;
compute a plurality of dimensions of credit worthiness for the individual, using the financial transaction data;
train at least one machine learning model, using the financial transaction data and the plurality of dimensions of credit worthiness as training data, to make at least one financial-related prediction for additional individuals; and
output the at least one machine learning model for use in making the at least one financial-related prediction for the one or more of the additional individuals.

2. The non-transitory computer-readable media of claim 1, wherein the financial transaction data includes historical transactions performed using at least one account of the individual with at least one financial institution.

3. The non-transitory computer-readable media of claim 1, wherein the plurality of dimensions of credit worthiness includes at least one lifestyle score.

4. The non-transitory computer-readable media of claim 3, wherein each lifestyle score of the at least one lifestyle score is a quantification of a spending pattern of the individual.

5. The non-transitory computer-readable media of claim 1, wherein the plurality of dimensions of credit worthiness includes at least one income score.

6. The non-transitory computer-readable media of claim 5, wherein each income score of the at least one income score is a quantification of an income of the individual.

7. The non-transitory computer-readable media of claim 1, wherein the plurality of dimensions of credit worthiness includes at least one financial behavior score.

8. The non-transitory computer-readable media of claim 6, wherein the at least one financial behavior score includes at least one priority expense score, and wherein each priority expense score of the at least one priority expense score is a quantification of a priority expense of the individual.

9. The non-transitory computer-readable media of claim 6, wherein the at least one financial behavior score includes at least one current credit-exclusivity score, and wherein each current credit-exclusivity score of the at least one current credit-exclusivity score is a quantification of a positive credit performance of the individual.

10. The non-transitory computer-readable media of claim 6, wherein the at least one financial behavior score includes at least one financial discipline score, and wherein each financial discipline score of the at least one financial discipline score is a quantification of a financial discipline of the individual.

11. The non-transitory computer-readable media of claim 6, wherein the at least one financial behavior score includes at least one red-flag event score, and wherein each red-flag event score of the at least one red-flag event score is a quantification of poor financial planning by the individual.

12. The non-transitory computer-readable media of claim 1, wherein the at least one financial-related prediction includes a prediction of risk in financial behavior of the additional individuals, when an amount of available financial transactions data for the additional individuals is below a threshold.

13. The non-transitory computer-readable media of claim 1, wherein the at least one financial-related prediction includes a prediction of imminent financial trouble for the additional individuals.

14. The non-transitory computer-readable media of claim 1, wherein the at least one financial-related prediction includes a prediction of fraud by the additional individuals.

15. The non-transitory computer-readable media of claim 1, wherein the at least one financial-related prediction includes a prediction of a need for a credit upgrade by the additional individuals.

16. The non-transitory computer-readable media of claim 1, wherein the device is further caused to:
use the at least one machine learning model to make the at least one financial-related prediction for the one or more of the additional individuals.

17. The non-transitory computer-readable media of claim 1, wherein the device is further caused to:
output one or more dimensions of credit worthiness of the plurality of dimensions of credit worthiness to a financial institution.

18. The non-transitory computer-readable media of claim 17, wherein the financial institution uses the one or more dimensions of credit worthiness as a basis for performing one or more financial-related activities for the individual.

19. A method, comprising:
at a computer system:
accessing financial transaction data for an individual;
computing a plurality of dimensions of credit worthiness for the individual, using the financial transaction data;
training at least one machine learning model, using the financial transaction data and the plurality of dimensions of credit worthiness as training data, to make at least one financial-related prediction for additional individuals; and
outputting the at least one machine learning model for use in making the at least one financial-related prediction for the one or more of the additional individuals.

20. A system, comprising:
a non-transitory memory storing instructions; and
one or more processors in communication with the non-transitory memory that execute the instructions to:
access financial transaction data for an individual;
compute a plurality of dimensions of credit worthiness for the individual, using the financial transaction data;
train at least one machine learning model, using the financial transaction data and the plurality of dimensions of credit worthiness as training data, to make at least one financial-related prediction for additional individuals; and
output the at least one machine learning model for use in making the at least one financial-related prediction for the one or more of the additional individuals.
